(19) United States
(12) Patent Application Publication
(10) Pub. No.: US 2015/0221051 A1
(43) Pub. Date: Aug. 6, 2015

(54) SYSTEM AND METHOD FOR REPAIR AND MAINTENANCE OF A PROPERTY

(71) Applicant: THE BYNG GROUP LTD., Vaughan (CA)

(72) Inventor: Frank Settino, Vaughan (CA)

(73) Assignee: THE BYNG GROUP LTD., Vaughan, ON (CA)

(21) Appl. No.: 14/420,700

(22) PCT Filed: Aug. 6, 2013
(86) PCT No.: PCT/CA2013/000697

§ 371 Date: Feb. 10, 2015

Related U.S. Application Data
(60) Provisional application No. 61/681,860, filed on Aug. 10, 2012.

(51) Int. Cl. G06Q 50/16; G06Q 10/00

(52) U.S. Cl. CPC G06Q 50/163; G06Q 10/20

(57) ABSTRACT

There is provided a system and method for long-term repair and maintenance of multi-unit buildings. Landlords and service providers may access the system to manage repair and maintenance of the units. Such repair and maintenance may comprise rehabilitation or major renovation work, refreshing or minor repairs, and for guardianship or periodic verification of the unit. Once a vacation notice is received for a unit, which had never been rehabilitated previously, rehabilitation of the newly vacated unit may be performed. If the unit had already been rehabilitated, refreshing of the newly vacated unit may be performed. Optional guardianship may also be performed in a currently occupied unit, which had been rehabilitated in the past.

### CROSS-REFERENCE TO RELATED APPLICATIONS

This patent application claims priority of U.S. provisional Application Ser. No. 61/681,860, filed on Aug. 10, 2012.

### TECHNICAL FIELD

The application relates generally to a system and method for repair and maintenance of a property.

### BACKGROUND OF THE ART

Many properties, such as multi family buildings, were built several decades ago, e.g. post-World War II. As a result, these buildings continue to age and many of the components in-suite are failing. In order to return the buildings' units to a suitable condition, landlords typically spend money to perform limited work, e.g. cosmetic repairs, in between tenants. However, this spending does not effectively address the deterioration issue of the components. In addition, performing major repair work while tenants are in the units is difficult to manage and cumbersome.

There is therefore a need for an improved system and method for repair and maintenance of properties.

### SUMMARY

In accordance with a first broad aspect, there is provided a system for managing repair and maintenance of at least one property, the system comprising a memory having stored therein maintenance history data indicative of at least one of a rehabilitation work and a refreshing work previously performed for the at least one property, the rehabilitation work comprising at least one renovation task and The refreshing work comprising at least one cosmetic repair task, a processor, and at least one application stored in the memory and executable by the processor for receiving vacancy notice data indicative of a vacancy of the at least one property, retrieving the maintenance history data from the memory, determining from the retrieved maintenance history data whether the rehabilitation work has been performed for the at least one property a predetermined time period prior to receipt of the vacancy notice data, if the rehabilitation work has not been performed the predetermined time period prior to receipt of the vacancy notice data, outputting a first control signal comprising instructions for causing the rehabilitation work to be performed for the at least one property, and otherwise, outputting a second control signal comprising instructions for causing the refreshing work to be performed for the at least one property.

In accordance with a second broad aspect, there is provided a computer-implemented method for managing repair and maintenance of at least one property, the method comprising executing on a processor program code for receiving vacancy notice data indicative of a vacancy of the at least one property, retrieving from a memory maintenance history data indicative of at least one of a rehabilitation work and a refreshing work previously performed for the at least one property, the rehabilitation work comprising at least one renovation task and the refreshing work comprising at least one cosmetic repair task, determining from the retrieved maintenance history data whether the rehabilitation work has been performed for the at least one property a predetermined time period prior to receipt of the vacancy notice data, if the rehabilitation work has not been performed the predetermined time period prior to receipt of the vacancy notice data, outputting a first control signal comprising instructions for causing the rehabilitation work to be performed for the at least one property, and otherwise, outputting a second control signal comprising instructions for causing the refreshing work to be performed for the at least one property.

In accordance with a third broad aspect, there is provided a computer readable medium having stored thereon program code executable by a processor for managing repair and maintenance of at least one property, the program code executable for receiving vacancy notice data indicative of a vacancy of the at least one property, retrieving from a memory maintenance history data indicative of at least one of a rehabilitation work and a refreshing work previously performed for the at least one property, the rehabilitation work comprising at least one renovation task and the refreshing work comprising at least one cosmetic repair task, determining from the retrieved maintenance history data whether the rehabilitation work has been performed for the at least one property a predetermined time period prior to receipt of the vacancy notice data, if the rehabilitation work has not been performed the predetermined time period prior to receipt of the vacancy notice data, outputting a first control signal comprising instructions for causing the rehabilitation work to be performed for the at least one property, and otherwise, outputting a second control signal comprising instructions for causing the refreshing work to be performed for the at least one property.

### DESCRIPTION OF THE DRAWINGS

Reference is now made to the accompanying figures in which:

FIG. 1 is a schematic diagram of a system for managing repair and maintenance of multi-unit buildings, in accordance with an illustrative embodiment;

FIG. 2a is a schematic diagram of an application running on the processor of FIG. 1;

FIG. 2b is a schematic diagram of the workflow management module of FIG. 2a;

FIG. 2c is a schematic diagram of the rehabilitation module of FIG. 2b;

FIG. 3a is a flowchart of the rehabilitation process implemented by the rehabilitation module of FIG. 2b;

FIG. 3b is a flowchart of the refreshing process implemented by the refreshing module of FIG. 2b;

FIG. 3c is a flowchart of the guardianship process implemented by the guardianship module of FIG. 2b;

FIG. 4a is a flowchart of a method for managing repair and maintenance of multi-unit buildings, in accordance with an illustrative embodiment;

FIG. 4b is a flowchart of the step of FIG. 3a of rehabilitating a vacated unit, in accordance with an illustrative embodiment;

FIG. 40 is a flowchart of the step of FIG. 3a of refreshing a vacated unit, in accordance with an illustrative embodiment;

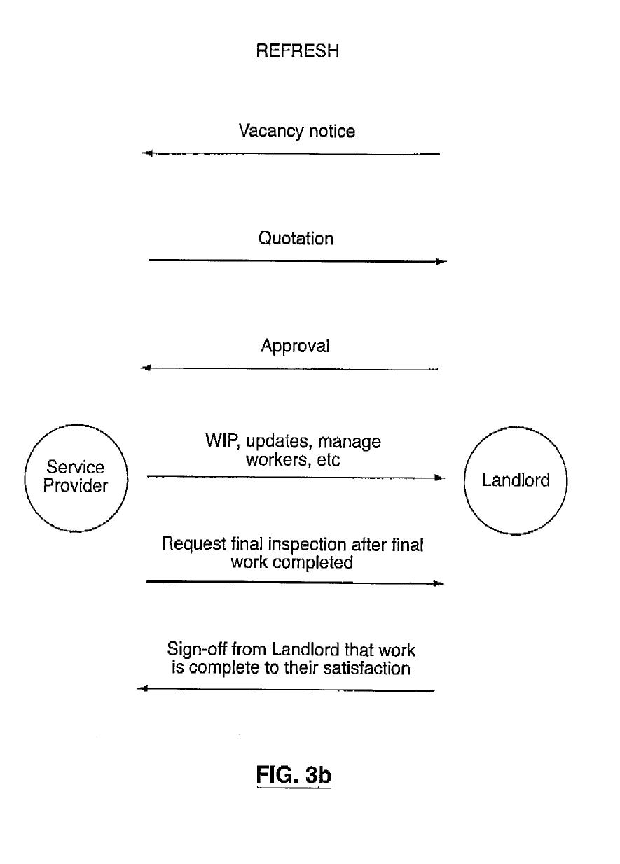

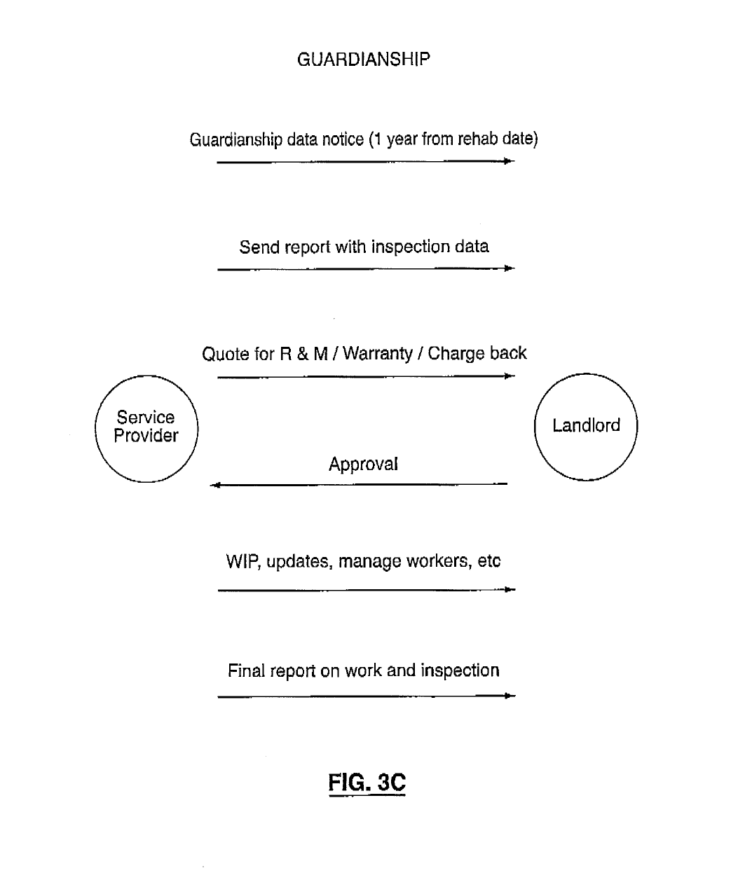

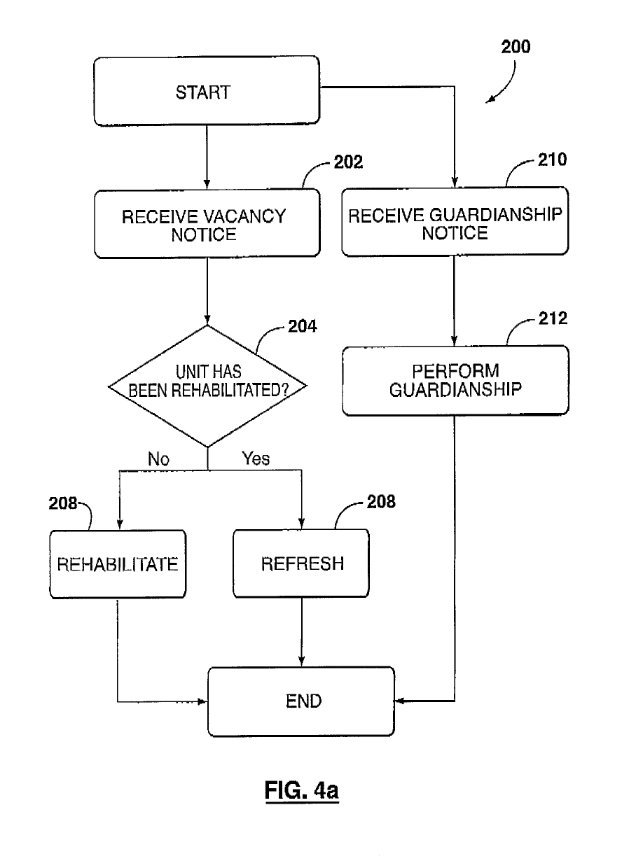

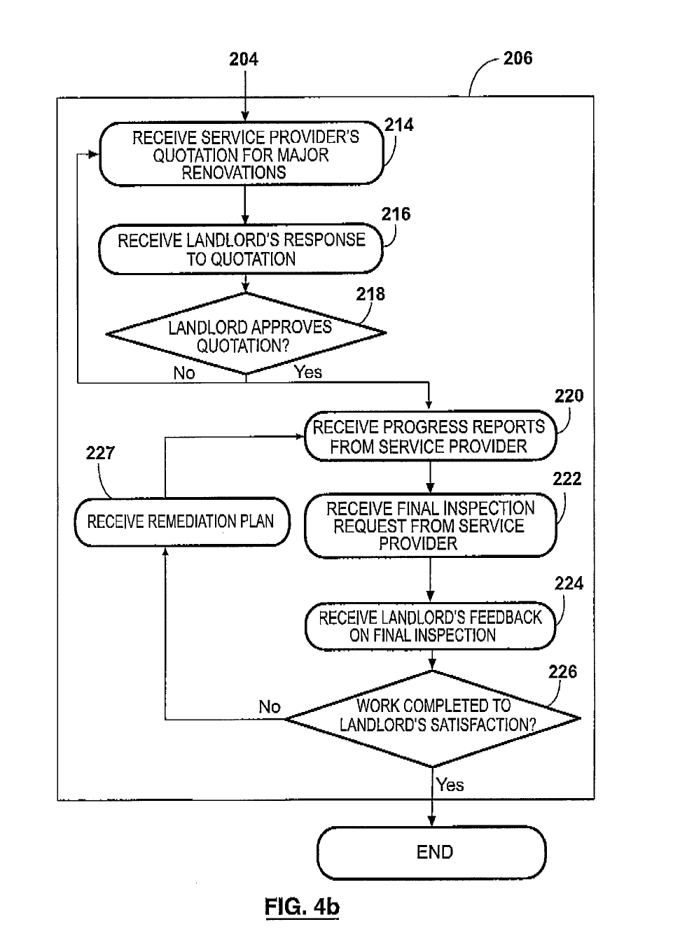

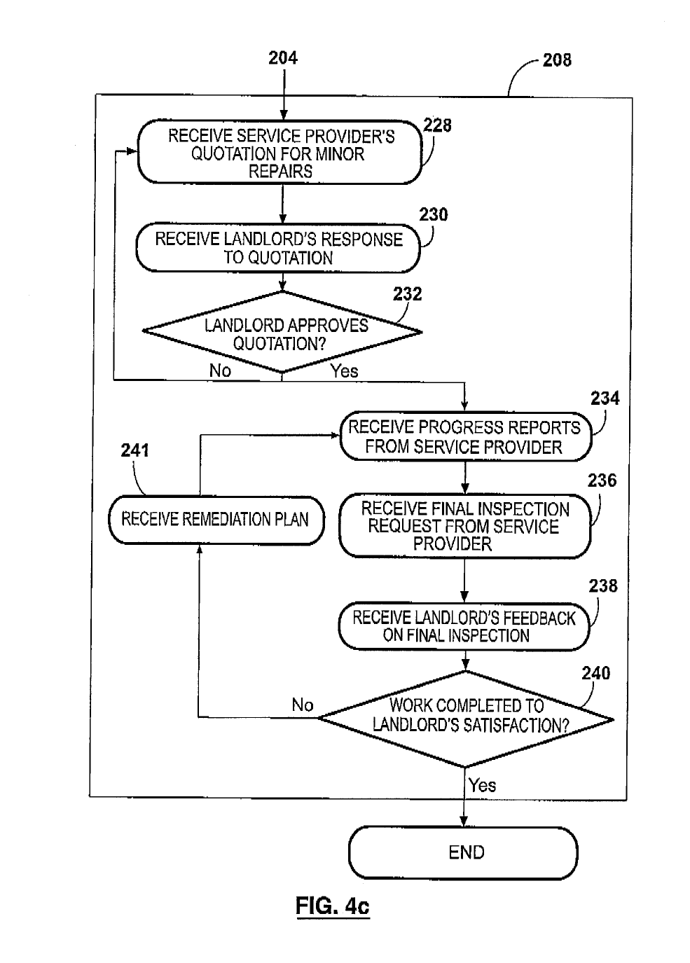

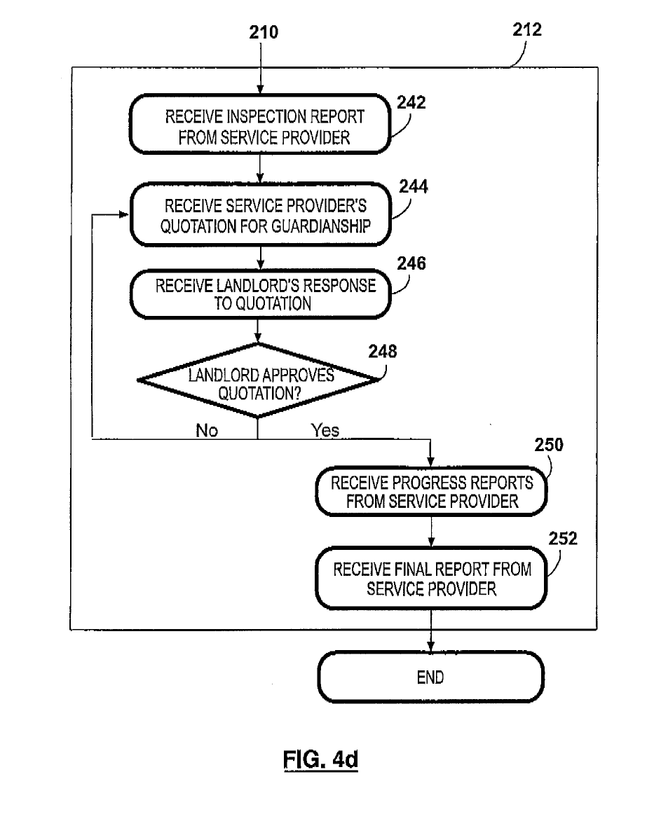

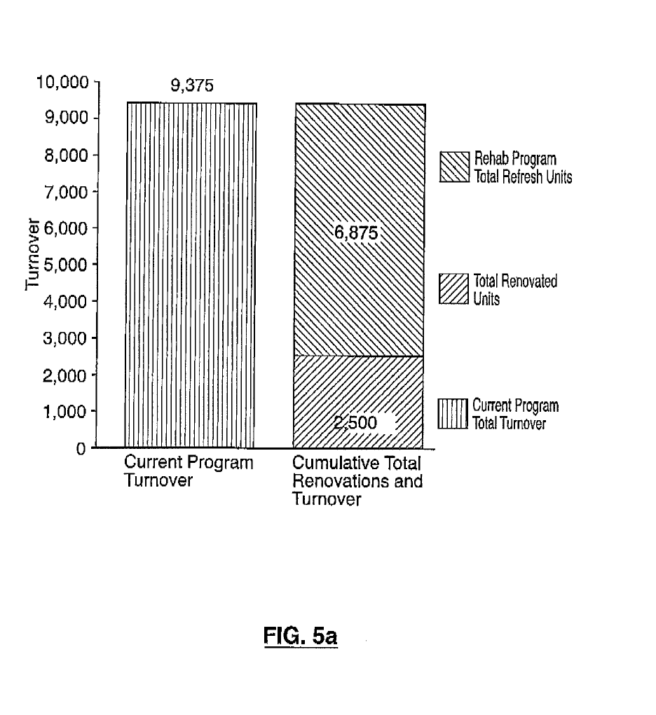

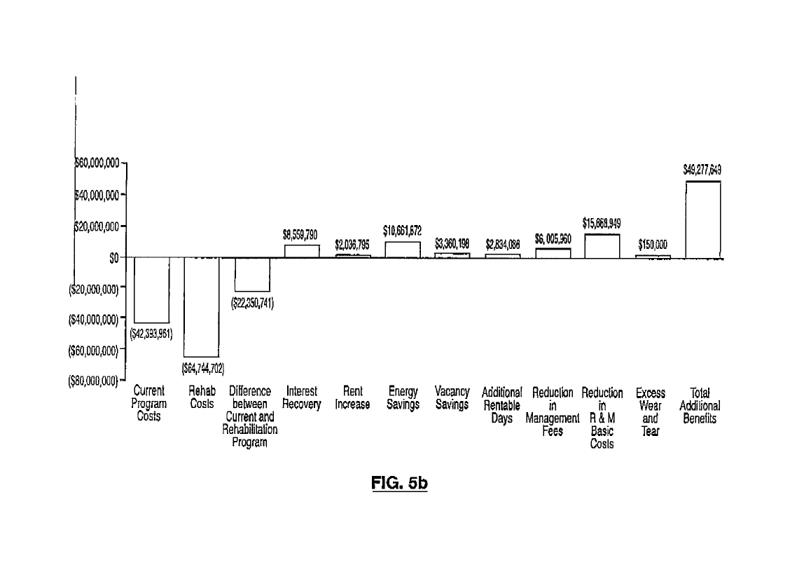

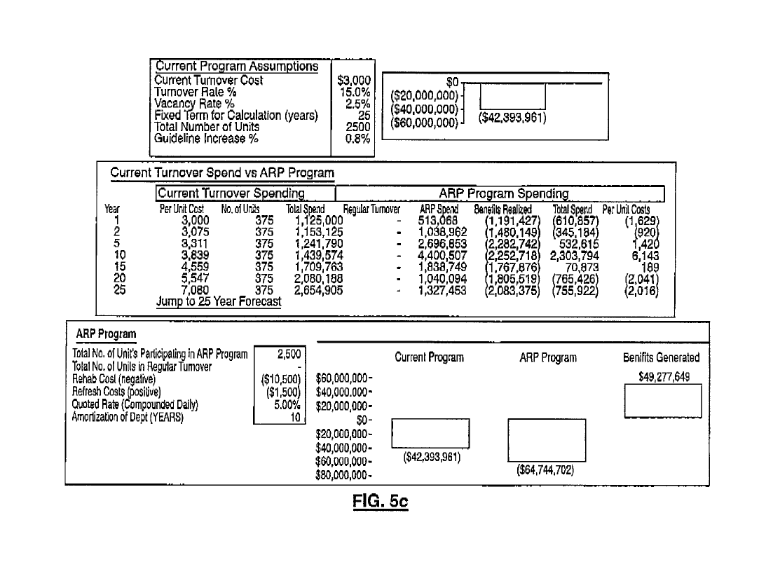

FIG. 4d is a flowchart of the step of FIG. 3a of performing guardianship work, in accordance with an illustrative embodiment;

FIG. 5a is a chart of the expected turnover for the repair and maintenance of multi-unit buildings, in accordance with an illustrative embodiment; and

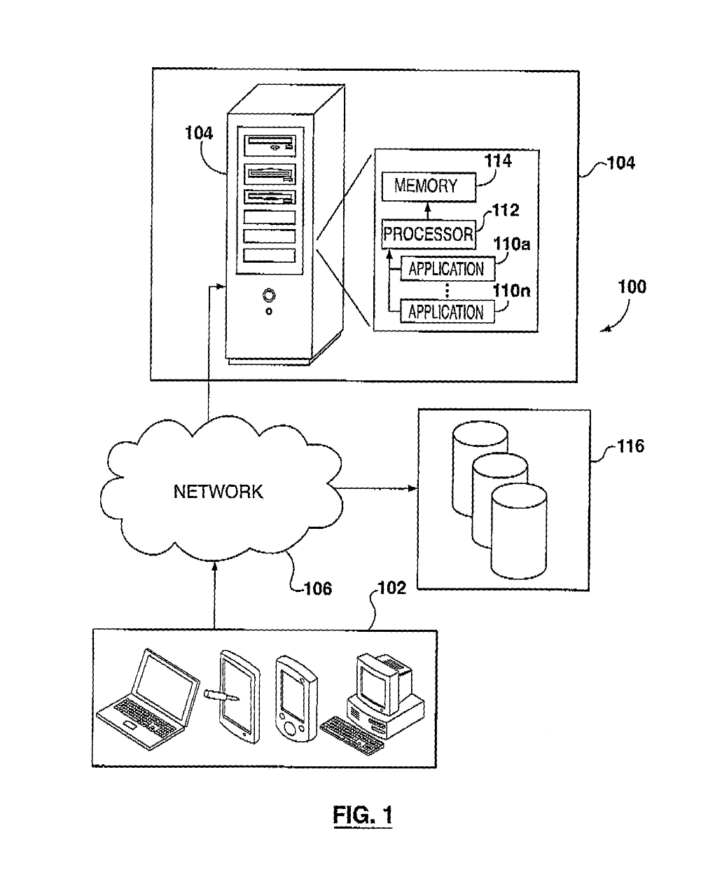

FIG. 5b is a chart of the benefits of using the system of FIG. 1 and the method of FIG. 3a, in accordance with an illustrative embodiment.

FIG. 5c is a chart of benefits when only a percentage of the total portfolio is in the system of FIG. 1 and the method of FIG. 3a, in accordance with an illustrative embodiment

### DETAILED DESCRIPTION

Referring to FIG. 1, there is illustrated a system 100 for managing repair and maintenance (R&M) of multi-unit buildings, such as residential buildings, commercial properties (e.g. office buildings), and other types of properties. Although described herein as relating to multi-unit buildings and rental units, it should be understood that the system 100 may also apply to hotels, motels, senior facilities, free-standing homes, and other establishments that provide lodging and that may need renovation. In addition, the system 100 may be used to renovate public transit facilities as well as the interior of cars of a transit system, such as a train or bus. For example, repair and maintenance of hallways, washrooms, and platforms of subways and bus stations may be managed using the system 100.

The system 100 is configured to support management of repair and maintenance of buildings including, but not limited to, rehabilitation work, refreshing work, and guardianship work. Rehabilitation illustratively includes major renovation work to a unit, including replacing significant components therein, such as flooring, walls, plumbing and electrical components, as well as replacing or repairing structural components, such as elevators, load-bearing wails, HVAC (heating, ventilation, and air conditioning) systems, and the like. Refreshing illustratively includes minor repair work, such as painting and cleaning, required to return the unit into proper condition for the next tenant. Thus, as used herein, the term rehabilitation relates to extensive and thorough work entailing replacement or restoration of significant components of a unit while the term refreshing relates to limited corrective or cosmetic work.

Guardianship illustratively relates to a recurring verification of a rental unit and may occur while the unit is still occupied by the tenant, e.g. prior to receipt of a vacancy notice indicating that the unit is or will be considered vacant due to the tenant leaving the unit. Guardianship may comprise performing safety checks, assessing whether a tenant has made changes without advising the landlord, and determining if there is any immediate need for repair or maintenance work for bringing the property back to a suitable condition or correcting defects thereof. For example, guardianship may enable to detect defects, such as electrical deficiencies, such as lights flickering, plumbing deficiencies, such as leaking faucets or stopped drains, and custodial deficiencies, such as broken windows. Safety checks may be performed to inspect fire exits and evaluate the state of charge of batteries used in smoke detectors and fire extinguishers. Guardianship may also be used to evaluate the state and condition of previously performed rehabilitation and/or refreshing work.

The repair and maintenance work described above may be triggered by maintenance issues and damages to the unit beyond the normal wear and tear. In this case, the work may be performed although a vacancy notice has not been received. This may be the result of tenant negligence or deliberate acts and the tenant may be charged for all costs related to the repairs. This is referred herein as a tenant chargeback. The amount of the chargeback may be determined by the hours of labour and cost of materials required to repair the unit. Examples of repairs that may be considered a tenant chargeback include, but are not limited to, doors that need to be repaired or replaced after one (1) year of tenancy, drywall patching in walls that needs to be repaired within six (6) months of tenancy, and new flooring that needs to be repaired or replaced after two (2) years of tenancy. Other examples of repairs that qualify for tenant chargeback will be readily understood by those skilled in the art.

The system 100 comprises a plurality of devices as in 102 adapted to communicate with a repair and maintenance system 104 over a network 106. The devices 102 may comprise any device, such as a personal computer, a personal digital assistant, a smart phone, or the like, which is configured to communicate over the network 106, such as the Internet, the Public Switch Telephone Network (PSTN), a cellular network, or others known to those skilled in the art. Although illustrated as being separate and remote from the devices 102, it should be understood that the repair and maintenance system 104 may also be integrated with the devices 102, either as a downloaded software application, a firmware application, or a combination thereof.

The repair and maintenance system 104 illustratively comprises one or more server(s) accessible via the network 106. For example, a series of servers corresponding to a web server, an application server, and a database server may be used. These servers are all represented by server 108 in FIG. 1. The server 108 may be accessed by a user, such as a landlord or a service provider, using one of the devices 102. The server 108 may comprise, amongst other things, a plurality of applications 110a . . . 110n running on a processor 112 coupled to a memory 114. It should be understood that while the applications 110a . . . 110n presented herein are illustrated and described as separate entities, they may be combined or separated in a variety of ways. It should also be understood that the terms “landlord” and “service provider”, as used herein, refer to both individual and corporate entities. A landlord may therefore represent a property management company or an individual, such as a superintendent, authorized to act at the property level for the management of the property. A service provider may represent a renovation company or an individual contractor that will be dispatched to a job site,.

One or more databases 116 may be integrated directly into the memory 114 or may be provided separately therefrom and remotely from the server 108 (as illustrated). In the case of a remote access to the databases 116, access may occur via any type of network 106, as indicated above. The various databases 116 described herein may be provided as collections of data or information organized for rapid search and retrieval by a computer. The databases 116 may be structured to facilitate storage, retrieval, modification, and deletion of data in conjunction with various data-processing operations. The databases 116 may consist of a file or sets of flies that can be broken down into records, each of which consists of one or more fields. Database information may be retrieved through queries using keywords and sorting commands, in order to rapidly search, rearrange, group, and select the field. The databases 116 may be any organization of data on a data storage medium, such as one or more servers.

The databases 116 illustratively have stored therein repair and maintenance history for all the rental units owned by the landlord. For example, the date specific repair and maintenance, such as rehabilitation work discussed further below, has been performed may be stored in the databases 116. Additional data, such as quotations and work-in progress (WIP) reports may also be stored in the databases 116. The databases 116 may also have stored therein additional details about the property, such as information about the floors, units, and unit types. For example, the databases 110 may store information related to each unit, such as the jurisdictional location, age and size thereof, whether a battery-powered smoke detector is installed in the unit, whether the unit is carpeted and, if so, any policies pertaining to carpets (e.g. rules for cleaning the carpet before a new tenant arrives), and whether the unit has iron pipes or aluminum wiring. Renovation policies, such as budget guidelines, rules to avoid certain renovations in specific units, painting and fixtures policies, predetermined timelines for renovations, a preferred contractors list, and other suitable policies, may also be stored in the databases 116. The information may be stored unit per unit, building per building, or, in cases where a single landlord owns multiple buildings, landlord per landlord.

In one embodiment, the databases 116 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

The memory 114 accessible by the processor 112 may receive and store data. The memory 114 may be a main memory, such as a high speed Random Access Memory (RAM), or an auxiliary storage unit, such as a hard disk, a floppy disk, or a magnetic tape drive. The memory 114 may be any other type of memory, such as a Read-Only Memory (ROM), or optical storage media such as a videodisc and a compact disc.

The processor 112 may access the memory 114 to retrieve data. The processor 112 may be any device that can perform operations on data. Examples are a central processing unit (CPU), a front-end processor, a microprocessor, and a network processor. The applications 110a . . . 110n are coupled to the processor 112 and configured to perform various tasks as explained below in more detail. An output may be transmitted to the client device 102, as will be discussed below.

In some embodiments, the system 104 may require users, i.e. the landlord, the service provider, or the tenant, to log in or otherwise gain authorized access to the system 104 through the use of a unique identifier. For this purpose, users illustratively register with the repair and maintenance system 104 by completing an application, thereby creating a unique profile or account. This may be done by accessing a website associated with the repair and maintenance system 104 using the device 102. Once registration is complete, each user is illustratively provided with a unique identifier, such as a username and password, associated with his/her profile. Any information associated with the user's account may be stored in the memory 114 and/or databases 116. The user may then access the repair and maintenance system 104 by logging on to the website using the identifier. Alternatively, the repair and maintenance system 104 may be installed on the device 102 as a software application, which may be launched by the user on the device 102 for accessing the repair and maintenance system 104. Although the system 104 may be accessed by multiple users simultaneously, multiple users may be prevented from viewing or updating information related to a given unit at the same time.

The identifier may be used to verify the identity of the user, for example to ensure that the user has the appropriate authority level for specific options provided by the system 104. Different interfaces (not shown) may indeed be presented to the user on the device 102 according to the information provided during registration and at log in. For instance, a user with higher authority, e.g. the landlord, may be provided with a detailed interface related to repair and maintenance tasks for various units while a user with lower authority, e.g. the service provider, may be provided with an interface related only to a specific repair and maintenance task, such as rehabilitation work, for a single unit In addition, the landlord may be provided with an option to approve a quotation whereas the service provider may only be able to view whether the quotation has been approved. Accessing the system 104 using the device 102 may then provide the landlord with a structured means to manage the repair and maintenance process, keep track of costs, and maintain a history for each unit.

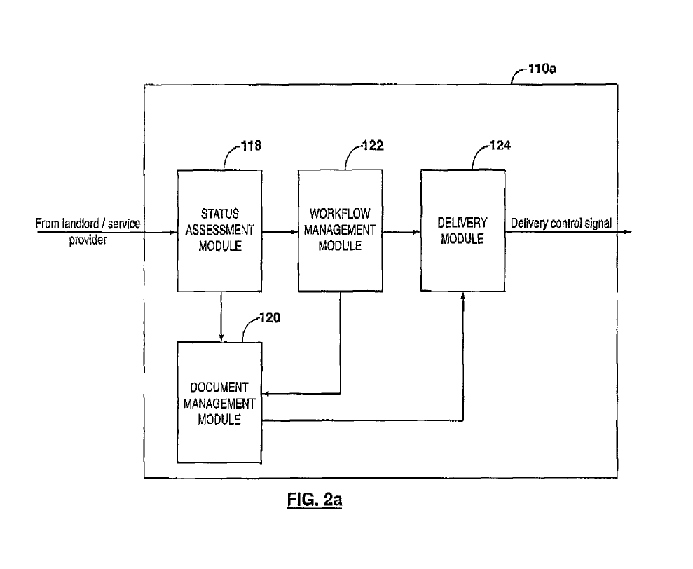

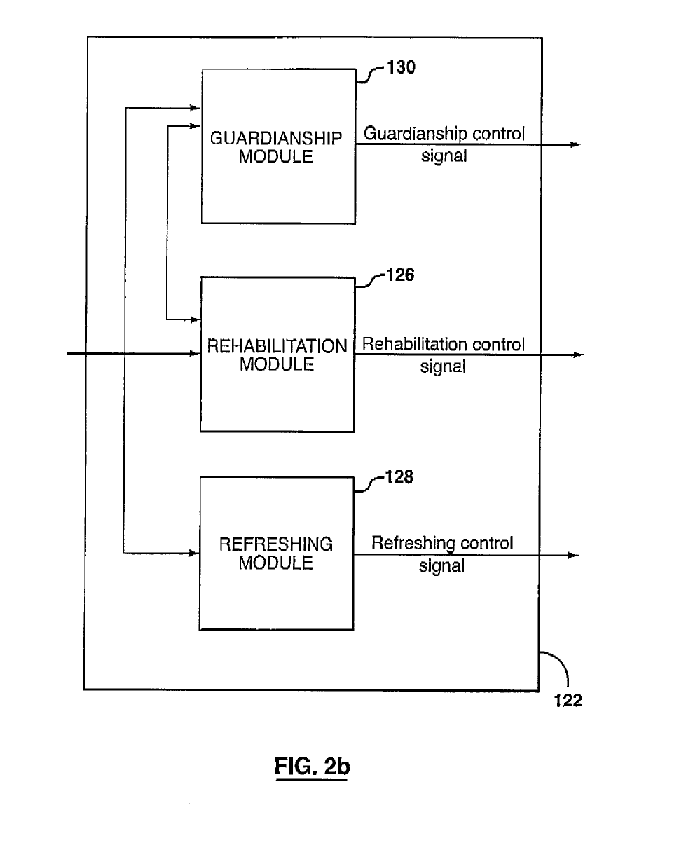

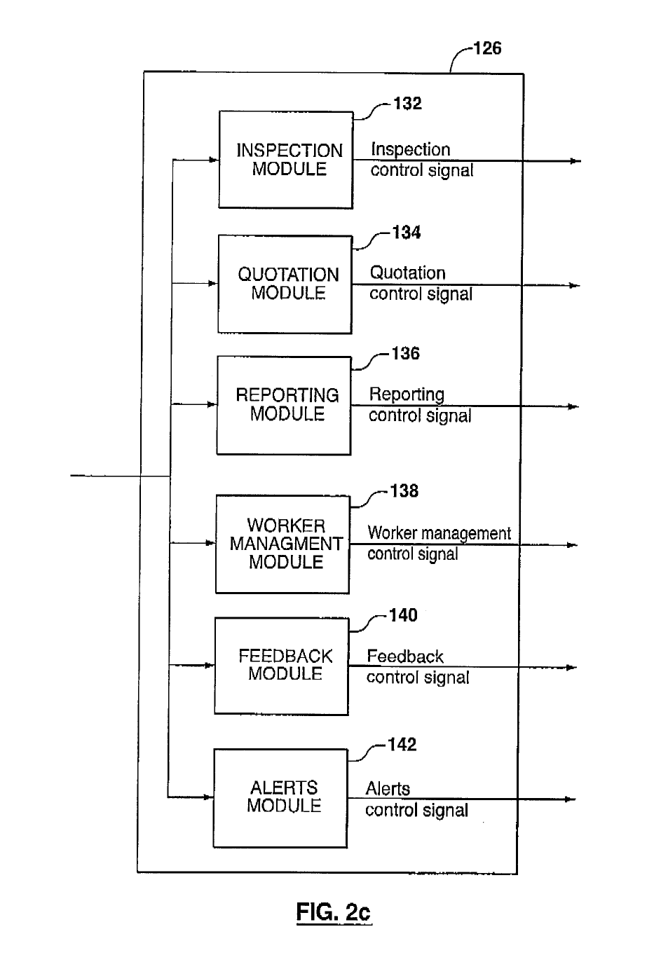

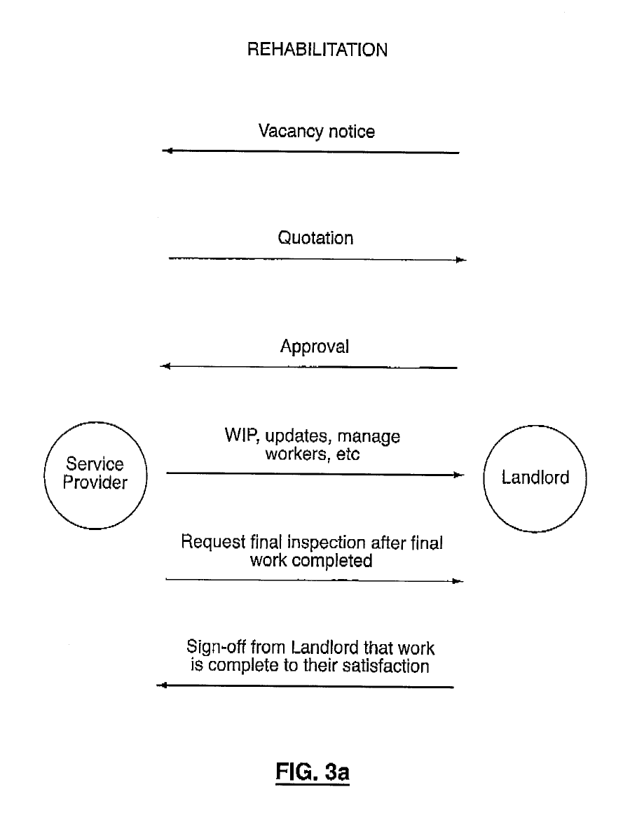

FIG. 2a is an exemplary embodiment of an application 110a running on the processor 108. The application 110a illustratively comprises a status assessment module 118, a document management module 120, a workflow management module 122, and a delivery module 124.

The status assessment module 118 illustratively receives an input from the landlord or service provider registered with the system 104. Such an input may comprise a vacancy notice, a quotation, a quotation approval, a progress report, or the like, as will be discussed further below. For the purpose of inputting data, the interface presented to the user, either a landlord, a tenant, or a service provider, on his/her device 102 may be used as an input means. For example, a graphical user interface comprising a plurality of user interface control elements, such as text boxes, electronic forms, drop-down boxes and menus (not shown), may be displayed on a screen of the device 102. It should however be understood that any suitable input device, such as a keyboard, a mouse, a microphone, or the like, may also be used to enter information into the system 104. Any input received from the user may be logged and stored in the memory 114 and/or databases 116 for future reference.

In order to determine how to proceed next, the status assessment module 118 may then determine what type of input has been received, which rental unit the input relates to, and the status of the repair and maintenance work for the unit in question. In particular and as will be discussed further below, the status assessment module 118 may determine from the input data whether the unit is to be rehabilitated or refreshed or whether guardianship is to be performed. The status assessment module 118 may also determine from the input data that specific repair and maintenance work, e.g. rehabilitation, is currently being carried out for the unit as well as which step of the repair and maintenance process is currently being carried out.

Once the status of the repair and maintenance has been determined, i.e. upon determining the repair and maintenance work to be performed or the status of the current repair and maintenance work being performed in the vacated unit, the status assessment module 118 may send the received input data to the document management module 120 so as to update the account of the landlord and/or service provider. The document management module 120 may for this purpose store the input data in the memory 114 and/or the databases 116. Depending on the authority level of each user, the data may subsequently be accessed by both parties, i.e, the landlord and/or service provider, or only by the party having the proper access privileges upon logging into the system 104. If it is desired to deliver the input data to the devices 102, the document management module 120 may send a control signal to the delivery module 124 to this effect. In turn, the delivery module 124 illustratively generates a delivery control signal for causing the input data to be transmitted directly to the devices 102. The delivery module 126 may indeed be adapted to communicate with the devices 102 to transmit data thereto via a suitable communication means, such as email, Short Message Service (SMS), Multimedia Messaging Service (MMS), instant messaging (IM), automated voice messages, and the like. Once the data is received at a device 102, it may be retrieved and accessed by the user without having to log into the system 104. The delivery control signal may also trigger rendering of the data on the device's interface. Such an interface may comprise one or more output devices (not shown), such as a display screen, a speaker, a vibrator, or any other suitable output device. It should be understood that the interface may simultaneously present data to multiple users, e.g. both the landlord and the service provider, on multiple devices 102.

The status assessment module 118 may further send the input data and the status information to the workflow management module 122 in order to move the repair and maintenance process along. As will be discussed in further detail below, upon processing the received data, the workflow management module 122 may then send a control signal to the delivery module 124 for delivering data to the devices 102 using the communication means discussed above. The workflow management module 122 may also send the control signal to the document management module 120 to cause the latter to update the account of the landlord and/or service provider with data output by the workflow management module 122.

As shown in FIG. 2b, the workflow management module 122 illustratively comprises a rehabilitation module 126, a refreshing module 128, and a guardianship module 130, each module managing the flow between the various tasks performed for each type of repair and maintenance work.

In particular, and referring to FIG. 2c in addition to FIG. 2b, each one of the rehabilitation module 126, the refreshing module 128, and the guardianship module 130 illustratively comprises a plurality of modules each performing a set of tasks related to each renovation phase as carried out by the rehabilitation module 126, the refreshing module 128, or the guardianship module 130. The set of tasks to be performed for each type of repair and maintenance work, e.g. rehabilitation, refreshing, or guardianship, may be stored in the memory 118 and/or databases 116. For instance, the rehabilitation module 126 may comprise an inspection module 132 for carrying out tasks related to the phase of inspecting the vacated unit, a quotations module 134 for carrying out tasks related to providing the landlord with quotations for the repair and maintenance work, and a reporting module 136 for carrying out tasks related to generating work-in progress and final reports for the landlord. The rehabilitation module 126 may further comprise a worker management module 138 for carrying out tasks related to managing service provider staff, a feedback module 140 for carrying out tasks related to managing any feedback received from the landlord, and an alerts module 142 for carrying out tasks related to alert generation. It should be understood that the refreshing module 128 and the guardianship module may also comprise the modules 132, 134, 136, 138, 140, and 142. It should also be understood that, depending on the tasks to be performed for a given repair and maintenance, more or less modules as in 132, 134, 136, 138, 140, and 142 may be used in each one of the rehabilitation module 126, the refreshing module 128, and the guardianship module 130.

In operation, the status assessment module 118 may first receive a vacancy or termination notice notifying that the unit rented to the tenant is to be (or has been) vacated. The vacancy notice may be input into the system 104 by the landlord using the device 102. Alternatively, the tenant may themselves input the vacancy notice into the system 104. In this case, the tenant may also be a user of the system 104 and may be provided with a unique identifier associated with his/her profile. The tenant may further be assigned a low authority level and may have limited access to information about the repair and maintenance work to be performed. For example, the tenant may be prevented from having access to quotations from the service provider.

The vacancy notice illustratively comprises vacancy data, including, but not limited to, a unique identifier of the aging unit to be vacated and an expected move-out date. Receipt of the vacancy notice may trigger an alert for the status assessment module 118 to query the memory 114 and/or databases 116 and retrieve the repair and maintenance history of the vacated unit. Upon accessing the history, the status assessment module 118 may then determine the type of repair and maintenance work to be carried out in the vacated unit. In particular, the status assessment module 118 may assess whether the vacated unit has been rehabilitated in the past and, as such whether the vacated unit simply needs to be refreshed or is in need of rehabilitation. Although the query for the units history is described herein as being automatically triggered in response to the receipt of the vacancy notice, it should be understood that such a query may also be manually triggered. Indeed, the vacancy notice may be presented to users, e.g. the landlord and the service provider, accessing the system 104 via their device 102. A service provider or a landlord viewing such a notice may manually perform a search through the unit's history to assess the type of repair and maintenance that should be performed in the vacated unit. In this case, the status assessment module 118 may be manually prompted to retrieve the repair and maintenance history of the vacated unit from the memory 114 and/or databases 116.

Once the repair and maintenance work to be performed for the vacated unit has been determined, the status assessment module 118 may send the vacancy notice to the document management module 120, which may in turn update the landlord's account with the vacancy notice. The document management module 120 may also send the vacancy notice to the delivery module 124 so that the latter may transmit the notice to the devices 102.

If the status assessment module 118 determines that the vacated unit has never been rehabilitated, or that a past rehabilitation was done more than a predetermined time period earlier, the vacancy data as well as the determined status information may be sent to the rehabilitation module 126 of the workflow management module 122 to initiate the rehabilitation process illustrated in FIG. 3a. Although described herein as being performed once, it should be understood that rehabilitation may be performed more than once throughout the service life of a rental unit, such as every fifteen years, twenty years, or any other predetermined time period as set by a system administrator and agreed upon by the landlord.

Since the status information illustratively indicates that rehabilitation is to begin in the vacated unit, the status assessment module 118 may send the vacancy data to the workflow management module 122 to be processed by the inspection module 132 so that the first step of the rehabilitation process, namely inspection and quotation, may be performed by the service provider. As such, the service provider may be prompted to inspect the unit in order to provide the landlord with an estimate of the work to be done. For this purpose, the inspection module 132 may query the memory 114 and/or the databases 116 to retrieve policies and other guidelines associated with the vacated unit to be rehabilitated. According to the retrieved information, the inspection module 132 may then generate an inspection control signal that comprises instructions for the service provider to carry out one or more inspection tasks for the vacated unit. The instructions may indicate to the service provider the specific measurements, information, and evidentiary documentation to be obtained to satisfy all foreseeable requirements stemming from quoting requirements, downstream requirements of individual contractors that will be performing the rehabilitation work, and any tenant chargeback considerations. For example, the instructions may indicate that, during a visit to the unit, the service provider is to thoroughly inspect the units floors for the purpose of rehabilitating the vacated unit by changing the entire flooring thereof.

As discussed above, the inspection control signal may then be sent to the document management module 120 for causing the inspection instructions to be associated with the accounts of the landlord and the service provider, thereby updating the accounts. The inspection control signal may also be sent to the delivery module 124 for causing the inspection instructions to be made accessible on the devices 102 of both the service provider and the landlord, as discussed above. In this manner, both parties may be informed of the next step of the rehabilitation work to be performed in the vacated unit. The service provider may then visit the vacated unit and carry out the inspection according to the specific instructions retrieved from his/her account or output to his/her device 102.

Once the visit has been completed, the service provider may prepare a quotation for the landlord, the quotation indicating the major renovations that need to be performed. In particular, the quotation may comprise pictures of the vacated unit, a description of the work to be carried out to rehabilitate the unit, materials required to perform the work, a task schedule, expected lees, as well as work identified as being outside of normal wear and tear during tenancy. Multiple choice quotations, which provide alternative renovation offers, may also be prepared. For example, the service provider may enable the landlord to choose between a first offer, e.g. replacing the unit's kitchen in white melamine for $2,000, and a second offer, e.g. replacing the kitchen in chocolate pear for $2,500. The service provider may submit the quotation to the system 104 using his/her device 102. The submitted quotation may then be received at the status assessment module 118, which may determine from the quotation the status of the repair and maintenance work. In particular, the status assessment module 118 may determine from the quotation that the vacated unit is undergoing rehabilitation and that the first step of rehabilitation, i.e. inspection and quotation, is complete and that the process is to move on to the next step, i.e. quotation approval.

The status assessment module 118 may then transmit the quotation and status information to the document management module 120 for updating the landlord and/or service provider accounts, the document management module 120 in turn transmitting the data to the delivery module 124 for transmission to the devices 102, as discussed above. The status assessment module 118 may also send the quotation and status information to the rehabilitation module 126 of the workflow management module 122 to enable further advancement of the rehabilitation process. In particular, the quotation and status information may be sent to the quotation module 134, which may generate from the received data a quotation control signal comprising instructions for prompting the landlord to provide a response to the quotation.

The quotation module 134 may further pre-approve or pre-deny the received quotation prior to prompting for approval of the quotation. Indeed, the quotation module 134 may compare the received quotation to a predetermined quotation cap set by at least one applicable policy, such as a budget policy, retrieved from the memory 114 and/or databases 116. If the quotation does not comply with the policy, for instance because the quoted work exceeds a maximum budget, the quotation module 134 may conclude that the quotation is to be refused and issue a message to that effect in the quotation control signal. The quotation control signal may then be transmitted to the delivery module 124 for transmission to the devices 102. As such, the denial of the quotation by the quotation module 134 may be notified to the landlord for further investigation. It should be understood that the quotation module 134 may compare the received quotation to other applicable guideline or policy information in order to determine whether the quotation complies with the guideline, and accordingly whether the quotation should be approved. For instance, the quotation module 134 may determine whether the quotation complies with the type of work, scope of work, and/or materials required to perform the work, which are approved by the applicable guideline or policy.

Upon receiving the quotation control signal and generating a delivery control signal accordingly, the delivery module 124 may prompt the landlord to enter on his/her device 102 a response to the quotation, i.e. approval or refusal thereof. This may, far example, be effected by presenting the landlord with user interface control elements, such as drop down boxes enabling the user to indicate his/her response to the quotation. The landlord may then verify the scope and need for the quoted work and, in turn, approve or refuse the quotation. Once the landlord enters a response, the latter may be received at the status assessment module 118, which may again assess the status of the repair and maintenance. At this point, the status assessment module 118 may determine that quotation approval has been completed and that the next step is to assess the landlord's feedback in order to enable initiation of the rehabilitation work. The status assessment module 118 may send the quotation response to the document management module 120 for updating the accounts of the landlord and/or service provider. The document management module 120 may in turn issue a control signal to the delivery module 124 to cause the quotation response to be delivered to the devices 102.

The status assessment module 118 may further send the quotation response to the feedback module 140 of the rehabilitation module 126. The feedback module 140 may determine from the received quotation response whether the landlord has approved or refused the quotation. In particular, the feedback module 140 may compare the received input to a set of predetermined options (e.g. “approved”/“denied” or “yes”/“no”) retrieved from the memory 114 and/or databases 116. The comparison enables to determine, which option the user selected, and accordingly the user's response to the quotation.

Once the assessment is performed, the feedback module 140 may retrieve from the memory 114 and/or databases 116 information to be presented to the users for further advancing the rehabilitation process. The retrieved information may be used to generate a feedback control signal adapted to be sent to the delivery module 124. For example, if the feedback module 140 determines that the landlord refused the quotation, the feedback control signal may comprise the landlord's response, reasons for the response, as well as instructions for the service provider to prepare a new quotation for submission to the landlord. The new quotation may be prepared according to the requirements of the landlord, as specified in his/her response to the quotation. Alternatively, if the quotation is approved, the feedback control signal may comprise instructions for the service provider to proceed with carrying out the rehabilitation work.

According to the quotation response, the alerts module 142 may also generate an alerts control signal for causing the delivery module 124 to communicate an alert or warning to the devices 102. It may for instance be desirable to communicate such an alert if the quotation is non-compliant or refused or if expected information, e.g. approval of the quotation before a predetermined time limit elapses, is not received.

Throughout the duration of the renovations, the service provider may periodically submit to the system 104 progress reports and other status updates. These reports are illustratively received at the status assessment module 118 which may transmit the received reports to the document management module 120 for updating the user accounts. The status assessment module 118 may also determine therefrom the status of the undergoing rehabilitation as well as the following steps. For example, if the status assessment module 118 receives a first work-in progress report, it may determine therefrom that the rehabilitation work is being carried out and that additional reports are to be received until the work is completed. The status assessment module 118 may then send the received report and status information to the reporting module 136 of the rehabilitation module 126. The reporting module 136 may generate a reporting control signal indicative of instructions for the service provider to carry on the rehabilitation and provide additional progress reports until completion of the Work. The status of the undergoing work, once determined, may then be subsequently updated while the work is being performed and new progress reports received.

The reporting module 136 may also be adapted to evaluate from the received progress reports whether the work effected by the service provider is on schedule. This may be done by comparing data from the received progress report with data retrieved from the memory 114 and/or databases 116. The retrieved data may comprise the expected schedule of the repair and maintenance work and comparison therewith may indicate whether the work is on track. The reporting control signal generated by the reporting module 136 may then comprise indications of progress of the rehabilitation work. The reporting module 136 may also communicate the comparison to the document management module 120 so that the user accounts may be updated with the information. Also, if the work is not on schedule, the alerts module 142 may generate an alerts control signal for causing the delivery module to communicate an alert to the devices 102 of the landlord and of the service provider.

It should be understood that, while the rehabilitation work is being performed, additional information related to the repair and maintenance work may also be submitted to the system 104 for access by both parties using their devices 102. For example, information related to management of service provider staff, e.g. contractors and technicians, may also be provided using the system 104. Indeed, work orders, contractor roles, work schedules, attendance records, worker performance records, and the like may be uploaded into the system 104 to be accessed by the landlord for overseeing purposes. Such information may be received at the status assessment module 118, which may determine therefrom the status of the rehabilitation work and send the received documents to the document management module 120 as well as to the worker management module 138 of the rehabilitation module 126. The worker management module 138 may in turn generate a control signal comprising instructions to be presented to the landlord and service provider. Such instructions may for example indicate that the number of workers is to be increased if the rehabilitation work is to be completed on time.

Once the work is completed and the final report is received at the status assessment module 118, the latter may determine therefrom that the remaining step is to obtain the landlord's sign-off on the completed work. As such, the status assessment module 118 may send the final report to the documents management module 120 for updating the accounts and send the report and status information to the reporting module 136. The reporting control signal generated by the reporting module 136 may then comprise instructions for the landlord to perform a final inspection of the rehabilitated unit. After the inspection, the landlord may enter his/her feedback into the system 104. For this purpose, the delivery module 124 may cause presentation of user selections, such as “satisfactory”/“unsatisfactory”, “good”/“medium”/“poor”, or “1 to 5” rankings, on the landlord's device 102. The feedback may be received at the status assessment module 118 who may again transmit the feedback data to the document management module 120 for updating the user accounts. The status assessment module 118 may also determine that the next step is assessment of the received feedback and may transmit the feedback data to the feedback module 140 of the rehabilitation module 126.

On the basis of the received feedback data, the feedback module 140 may then assess whether the work was completed to the landlord's satisfaction. This may be done by comparing the received feedback data to a set of predetermined feedback options stored in the memory 114 and/or databases 116. According to the comparison, the feedback module 140 may then retrieve from the memory 114 and/or databases 116 specific information to be displayed to the user. For example, if the received feedback indicates the landlord's dissatisfaction with the work completed by the service provider, the latter may be required to perform additional or corrective rehabilitations tasks to implement the original rehabilitation plan. The corrective tasks may be specified in the landlord's feedback. Alternatively, a remediation plan may be put in place instead of correcting the original rehabilitation plan. The remediation plan may indicate a new set of repair and maintenance tasks to be performed to meet the landlord's requirements The feedback module 140 may thus generate a feedback control signal comprising instructions indicative of the specific corrective tasks or the remediation plan to be performed. While the corrective measures are being taken to complete the rehabilitation work to the landlord's satisfaction or the remediation plan is being carried out, new progress reports and updates may be received from the service provider at the status assessment module 118 and transmitted to the document management module 120 and the workflow management module 122 as discussed above.

If the landlord's feedback indicates satisfaction with the rehabilitation work, the feedback control signal may indicate that the rehabilitation work is complete and an alert to this effect may be transmitted to the devices 102 via the delivery module 124.

FIG. 3b illustrates the refreshing process. If the status assessment module 118 determined from the received vacancy notice that the vacated unit has been rehabilitated in the past, the status assessment module 118 may conclude that refreshing is to be carried out. Thus, the vacancy data may be sent by the status assessment module 118 to the refreshing module 128 of the workflow management module 122 in order to initiate the refreshing process. Refreshing is illustratively performed on several occasions throughout the service life of a rental unit. In some embodiments, refreshing is performed every time a unit is vacated by a tenant after the unit has been rehabilitated,

Similarly to the rehabilitation work, upon receiving the vacancy data, the inspection module 132 of the refreshing module 128 may query the memory 114 and/or the databases 116 to retrieve the policies associated with the vacated unit to be refreshed. The inspection module 132 may then generate an inspection control signal that comprises instructions or the service provider to inspect the vacated unit for the purpose of carrying out one or more refreshing tasks, e.g. clean the unit's carpeting and apply a fresh coat of paint. The service provider's quotation may then be received at the status assessment module 118, which may determine therefrom that landlord approval is required. As such, the landlord may be prompted by the quotation module 134 to respond to the quotation. The landlord's feedback is then received at the status assessment module 118 and assessed at the feedback module 140. Once it is determined that the landlord approved the quotation, the refreshing work may begin.

As in rehabilitation, refreshing may require the service provider to submit progress reports, status updates, and the like, to the system 104. As described above with reference to rehabilitation, any input data submitted to the system 104 during the refreshing process is illustratively received at the status assessment module 118. The status assessment module 118 may then determine from the received input data the status of the refreshing work being carried out as well as the next steps of the process. The status assessment module 118 may then send the received input data and the status information to the document management module 120 to update the accounts of the landlord and/or the service provider. In order to advance the refreshing process, the status assessment module 118 may also send the input data to a selected one of the reporting module 136, the worker management module 138, the feedback module 140, and the alerts module 142 of the refreshing module. The selected module may then generate a control signal to be sent to the delivery module 124 for causing delivery of data to the devices 102. The control signal may comprise specific instructions to the service provider for enabling progression of the refreshing work. Once the work is complete to the landlord's satisfaction as determined from the landlord feedback in a manner similar to rehabilitation, an alert may be communicated to the devices 102 to this effect.

Referring to FIG. 3c, the system 104 may further comprise an optional guardianship program feature, which may be provided to complement the rehabilitation and refreshing features discussed above. Guardianship verifications may occur on a yearly basis. It should however be understood that any other suitable time interval, such as every six (6) months, may also apply. When guardianship work is to be performed, a guardianship notice may be set to be automatically triggered at a predetermined time interval, such as one (1) year, from the date a unit has been rehabilitated. For this purpose, the guardianship module 130 of FIG. 2b may receive the guardianship notice from the rehabilitation module 126 once the predetermined time interval has elapsed. It should be understood that the guardianship notice may also be automatically triggered a predetermined time interval after the unit has been refreshed. Alternatively, the guardianship notice may be manually input into the system 104 by a user, such as the landlord, using the device 102 as an input means. In yet another embodiment, a landlord may manually trigger a guardianship notice when a tenant has reported one or more deficiencies in the unit that should be addressed in the short term. Other events, such as a fire or flooding, may also cause the landlord to trigger a guardianship notice.

When the guardianship is manually triggered, it may be received at the status assessment module 118. Upon receiving the guardianship notice, the status assessment module 118 may determine therefrom that guardianship work is to be carried out in a given rental unit. The status assessment module 118 may send the guardianship data and status information to the document management module 120 to update the user accounts and to the guardianship module 130 of the workflow management module 122. If the guardianship notice is automatically triggered, it is illustratively received at the guardianship module 130 directly, without intervention of the status assessment module 118.

In particular, the guardianship data may be sent to the inspection module 132 of the guardianship module 130 for the purpose of issuing inspection instructions to the service provider, as described above with regards to rehabilitation. The service provider may therefore perform guardianship verifications in the unit and an inspection report and quotation may be received at the status assessment module 118. The status assessment module 118 may determine from the received data that approval of the landlord is required and the landlord may be prompted by the quotation module 134 to respond to the quotation. The landlord's feedback is then received at the status assessment module 118 and assessed at the feedback module 140. Once it is determined that the landlord approved the quotation, the guardianship work, e.g. rehabilitation or refreshing of the unit after guardianship verifications have been performed, may begin.

Similarly to the rehabilitation and refreshing work, guardianship may require the service provider to submit progress reports, status updates, and the like, to the system 104. Any input data may be submitted to the system 104 and received at the status assessment module 118. The status assessment module 118 may then determine from the received input data the status of the guardianship work being carried out as well as the next steps of the process. The status assessment module 118 may then send the received input data and the status information to the document management module 120 to update the accounts of the landlord and/or the service provider. In order to advance the guardianship process, the status assessment module 118 may also send the input data to a selected one of the reporting module 136, the worker management module 138, and the alerts module 142 of the refreshing module. The selected module may then generate a control signal to be sent to the delivery module 124 for causing delivery of data to the devices 102. The control signal may comprise specific instructions to the service provider for enabling progression of the guardianship work. Once the status assessment module 118 receives a final report indicating that the guardianship work is complete, an alert may be communicated to the devices 102.

Referring to FIG. 4a, a computer-aided method 200 for managing repair and maintenance of multi-unit residential buildings will now be described. A first step 202 of the method 200 comprises receiving a vacancy notice for a unit of the building. Once the vacancy notice has been received at step 202, the method 200 may then determine at step 204 whether the unit has been rehabilitated prior to receiving the vacancy notice. This may be effected by retrieving the repair and maintenance history of the unit from the memory 114 and/or databases 116, as discussed above. If the unit has never been rehabilitated (or rehabilitation occurred a predetermined time ago), rehabilitation may be performed at step 206. Alternatively, if the unit has been rehabilitated previously, refreshing may be performed at step 208, if a guardianship feature is provided and rehabilitation has been performed in the past, the method may receive at step 210 a guardianship notice. As discussed above, the guardianship notice may be automatically or manually triggered every year on the anniversary of the rehabilitation of the unit. Guardianship may then be performed at step 212.

Referring now to FIG. 4b, the step 206 of rehabilitating the vacated unit may comprise receiving at step 214 a quotation from the service provider indicating the major renovations that need to be performed. As described above, this quotation may be uploaded into the system 104 subsequent to the service provider visiting the unit and estimating the work to be carried out. The quotation, once received, may have to be approved by the landlord whose response to the quotation, i.e, approval or refusal thereof, may be received at step 216.

Step 218 may then comprise determining whether the landlord has approved or refused the quotation. If the quotation has been refused, the method 200 may go back to the step 214 of receiving a quotation from the service provider. Indeed, the quotation process may be iterative and if a quotation is refused by the landlord, the service provider may be asked to provide a new quotation for approval. The process may be repeated until the landlord and the service provider reach an agreement. Although not illustrated, it should be understood that approval of the quotation may also comprise an automated process. For example and as described above, the quotation, once received, may be automatically compared to a predetermined quotation cap set by at least one applicable policy, such as a budget policy.

If the landlord approves the quotation, the rehabilitation work may then be performed by the service provider with progress reports and other status updates being received periodically at step 220. Once the rehabilitation work is completed, the service provider may request the landlord to perform a final inspection. The final inspection request may be received at step 222 and viewed by the landlord accessing the system 104 using his/her device 102. After performing the final inspection, the landlord may then provide feedback, which may be received at step 224. According to the landlord's feedback, step 226 may then comprise evaluating whether the work was completed to the landlord's satisfaction. If the landlord's feedback indicates dissatisfaction with the work completed by the service provider, the latter may be required to perform additional or corrective rehabilitations tasks. Instructions to perform such tasks may be specified in the feedback received form the landlord at step 224. A remediation plan to be carried out instead of modifying the original renovation plan may also be prepared and received at step 227. As such, the method 200 may go back to step 220 where new progress reports and updates are received from the service provider while corrective measures are being taken to complete the rehabilitation work to the landlord's satisfaction.

Once the landlord is satisfied with, the rehabilitation work completed by the service provider, e.g. sign-off of the completed work is provided in the landlord's feedback received at step 224, step 206 may end. Although not shown, it should be understood that, after sign-off, an invoice may be issued by the service provider to the landlord and an electronic version of the invoice may thus be received prior to step 206 ending. In addition to indicating the final costs to be paid for the work completed by the service provider, the invoice may contain backup evidentiary documentation such as before and/or after photographs of the rehabilitated unit, certificates or permits obtained, if any, proofs of attendance, and other suitable documentation.

Referring now to FIG. 4c, the step 208 of refreshing the vacated unit is illustratively similar to the step 206 of rehabilitating the unit, except for the type of work to be performed. The step 208 may indeed comprise receiving at step 228 a quotation for minor repairs to be carried out, receiving the landlord's response to the quotation at step 230 and assessing whether the landlord approves the quotation at step 232. If the landlord refuses the quotation, the quotation process may start over at step 228. Otherwise, the refreshing work may start and progress reports and status updates may be received from the service provider at step 234. Once the refreshing work is completed, a final inspection request may be received from the service provider at step 236 and the landlord's feedback subsequent to the final inspection may be received at step 238. Step 240 may assess whether the service provider's work is to the landlord's satisfaction. If this is not the case, additional refreshing tasks may be carried out with the method 200 then going back to step 234 where new progress reports may be received. A remediation plan may also be prepared and received at step 241 prior to receiving the new progress reports. If the work performed by the service provider is to the landlord's satisfaction, the step 208 may end.

Referring to FIG. 4d, the step 212 of performing guardianship for the vacated unit may comprise receiving at step 242 an inspection report from the service provider subsequent to guardianship verifications, as discussed above. The service provider may further provide a quotation for any repair and maintenance or warranty work to be performed as well as any chargeback. The quotation may be received at step 244.

Once the inspection report and quotation are received, they may be accessed by the landlord who may then indicate his/her approval of the quotation. The response to the quotation may be loaded into the system 104 and received at step 246. Step 248 may then assess whether the landlord approved the quotation. If the quotation was refused, the quotation process may be started over by going back to step 244 where a new quotation may be received from the service provider. Otherwise, the guardianship work may be performed by the service provider with progress reports being periodically received at step 250. A final report may further be received from the service provider at step 252 once the guardianship work is completed. The landlord may monitor the guardianship work performed by the service provider by logging into the system 104 to access such reports. Although not illustrated, it should be understood that similarly to rehabilitation and refreshing, the landlord may further evaluate the guardianship work by indicating satisfaction or dissatisfaction therewith on the basis of the received final report. If the landlord is dissatisfied with the work, corrective tasks or a remediation plan may have to be carried out by the service provider and new progress reports may be received at step 250.

As discussed above with reference to the system 100, it should be understood that any data, such as progress reports, inspection reports, quotations, approvals, and landlord feedback, received from either party, i,e. the landlord or the service provider at steps 206, 208, and 212 of the method 200 may be accessed by the other party via their device 102, provided the other party has the required authority level. For this purpose and although not illustrated in FIG. 4b, FIG. 4c, and FIG. 4d, the steps 206, 208, and 212 may comprise storing the received information in both parties' accounts and/or delivering the received information to the devices 102 using a suitable communication means, as discussed above. It should also be understood that, although not illustrated, the method 200 may comprise the landlord advising the tenant of dates at which inspections as well as the rehabilitation, refreshing, or guardianship work is to take place. The tenant, if registered with the system 104, may then use his/her device 102 to access the system 104 and view the notifications.

FIG. 5a shows a chart of the expected turnover for the long-term repair and maintenance of multi-unit residential buildings as implemented using the system 100 and the method 200. In this example, the repair and maintenance is to take place over a period of twenty-five years, with the landlord owning a total of 1,000 units. With a turnover rate of 10%, the turnover is expected to be 100 units per year for a total of 2,500 units over twenty-five years. Since all units should be rehabilitated at least once throughout their service life, the total number of units rehabilitated will be 1,000 units, thus resulting in 1,500 units being refreshed over the twenty-year period.

FIG. 5b shows the potential benefits of using the system 100 and the method 200. Although rehabilitation implies major renovation work, which is more expensive than standard turnover repair and maintenance (R&M), i.e. cosmetic repairs in between tenants, rehabilitating and refreshing units throughout their service life may reduce overall renovation costs. For instance, the example illustrated in FIG. 5b assumes turnover R&M costs of $2,800 per unit, rehabilitation costs of $10,000 per unit, and refreshing costs of $1,700 per unit. As illustrated, the costs (“Rehab Costs”) of rehabilitating 1,000 units and refreshing 1,500 units over twenty-five years prove to be higher than the costs (“Current Program Costs”) of effecting standard turnover R&M of 2,500 units over the same period.

FIG. 5c illustrates an input summary when using the system 100 and the method 200 when for a portion of a portfolio of rental units. Typically the landlord or end-user has the ability to put all of their rental units into the system 100. However the system 100 may be customized to allow the end-user to only put in a percentage of the total portfolio into the system 100 if they wish. FIG. 5c illustrates a summary comparison of the total spending for the portion of the portfolio left in a traditional system versus the spending under the system 100 depending on the percentage of the portfolio the end-user decides to include as well as demonstrating the affect on the per unit cost within their overall spending model.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. It should be noted that the present invention can be carried out as a method, can be embodied in a system, and/or a computer readable medium. The embodiments of the invention described above are intended to be exemplary only. The scope of the invention is therefore intended to be limited solely by the scope of the appended claims.

1. A system for managing repair and maintenance of at least one property, the system comprising:
a memory having stored therein maintenance history data indicative of at least one of a rehabilitation work and a refreshing work previously performed for the at least one property, the rehabilitation work comprising at least one renovation task and the refreshing work comprising at least one cosmetic repair task;
a processor; and
at least one application stored in the memory and executable by the processor for
receiving vacancy notice data indicative of a vacancy of the at least one property,
retrieving the maintenance history data from the memory,
determining from the retrieved maintenance history data whether the rehabilitation work has been performed for the at least one property a predetermined time period prior to receipt of the vacancy notice data,
if the rehabilitation work has not been performed the predetermined time period prior to receipt of the vacancy notice data, outputting a first control signal comprising instructions for causing the rehabilitation work to be performed for the at least one property, and
otherwise, outputting a second control signal comprising instructions for causing the refreshing work to be performed for the at least one property.

2. The system of claim 1, wherein the at least one application is executable by the processor for receiving guardianship notice data indicative that guardianship work is to be performed for the at least one property and outputting a third control signal comprising instructions for causing the guardianship work to be performed, the guardianship work comprising assessing a current state of the at least one property and, if the current state is indicative of at least one defect of the at least one property, performing at least one corrective task for correcting the at least one defect.

3. The system of claim 2, wherein the at least one application is executable by the processor for receiving the guardianship notice data a predetermined time interval after completion of one of the rehabilitation work and the guardianship work.

4. The system of claim 3, wherein the memory has stored therein the instructions for causing a corresponding one of the rehabilitation work, the refreshing work, and the guardianship work to be performed, and further wherein the at least one application is executable by the processor for retrieving the instructions from the memory, generating one of the first, the second, and the third control signal comprising the retrieved instructions, and outputting the one of the first, the second, and the third control signal.

5. The system of claim 4, wherein the memory has stored therein the instructions for at least one of inspecting the at least one property, providing a quotation for performing the corresponding one of the rehabilitation work, the refreshing work, and the guardianship work, performing one of the at least one renovation task, cosmetic repair task, and corrective task associated with the corresponding one of the rehabilitation work, the refreshing work, and the guardianship work, and generating at least one progress report while performing the one of the at least one first, second, and third task.

6. The system of claim 5, wherein the at least one application is executable by the processor for receiving quotation data for the corresponding one of the rehabilitation work, the refreshing work, and the guardianship work, the quotation data comprising at least one of a description, a cost estimate, and a schedule for the corresponding one of the rehabilitation work, the refreshing work, and the guardianship work.

7. The system of claim 6, wherein the memory has stored therein guideline data indicative of at least one guideline applicable for performing the corresponding one of the rehabilitation work, the refreshing work, and the guardianship work, and further wherein the at least one application is executable by the processor for comparing the received quotation data to the guideline data, approving the quotation if the received quotation data complies with the guideline data, and rejecting the quotation otherwise.

8. The system of claim 7, wherein the memory has stored therein the guideline data comprising a quotation cap set in accordance with the at least one guideline and further wherein the at least one application is executable by the processor for rejecting the quotation if the cost estimate exceeds the quotation cap and approving the quotation otherwise.

9. The system of claim 7, wherein the at least one application is executable by the processor for, further to rejecting the quotation, outputting a notification signal indicative of rejection of the quotation and prompting for new quotation data to be received.

10. The system of claim 6, wherein the at least one application is executable by the processor for receiving progress report data indicative of a progression of the corresponding one of the rehabilitation work, the refreshing work, and the guardianship work, comparing the received progress report data to the schedule for determining a status of the corresponding one of the rehabilitation work, the refreshing work, and the guardianship work, and outputting a fourth control signal comprising instructions for causing advancement of the corresponding one of the rehabilitation work, the refreshing work, and the guardianship work in accordance with the schedule.

11. The system of claim 10, wherein the at least one application is executable by the processor for detecting a deviation from the schedule of the corresponding one of the rehabilitation work, the refreshing work, and the guardianship work and for outputting an alert signal indicative of the deviation.

12. The system of claim 10, wherein the at least one application is executable by the processor for detecting completion of the corresponding one of the rehabilitation work, the refreshing work, and the guardianship work and for updating the status of the corresponding one of the rehabilitation work, the refreshing work, and the guardianship work accordingly.

13. The system of claim 12, wherein the at least one application is executable by the processor for determining from the received report data that the completion of the corresponding one of the rehabilitation work, the refreshing work, and the guardianship work is not satisfactory and for outputting the fourth control signal comprising instructions for performing at least one additional task for bringing the corresponding one of the rehabilitation work, the refreshing work, and the guardianship work to satisfaction.

14. A computer-implemented method for managing repair and maintenance of at least one property, the method comprising executing on a processor program code for:
receiving vacancy notice data indicative of a vacancy of the at least one property,
retrieving from a memory maintenance history data indicative of at least one of a rehabilitation work and a refreshing work previously performed for the at least one property, the rehabilitation work comprising at least one renovation task and the refreshing work comprising at least one cosmetic repair task,
determining from the retrieved maintenance history data whether the rehabilitation work has been performed for the at least one property a predetermined time period prior to receipt of the vacancy notice data,
if the rehabilitation work has not been performed the predetermined time period prior to receipt of the vacancy notice data, outputting a first control signal comprising instructions for causing the rehabilitation work to be performed for the at least one property, and
otherwise, outputting a second control signal comprising instructions for causing the refreshing work to be performed for the at least one property.

15. The method of claim 14, further comprising receiving guardianship notice data indicative that guardianship work is to be performed for the at least one property and outputting a third control signal comprising instructions for causing the guardianship work to be performed, the guardianship work comprising assessing a current state of the at least one property and, if the current state is indicative of at least one defect of the at least one property, performing at least one corrective task for correcting the at least one defect.

16. The method of claim 15, further comprising outputting one of the first, second, and third control signal comprising instructions for at least one of inspecting the at least one property, providing a quotation for performing the corresponding one of the rehabilitation work, the refreshing work, and the guardianship work, performing one of the at least one renovation task, cosmetic repair task, and corrective task associated with the corresponding one of the rehabilitation work, the refreshing work, and the guardianship work, and generating at least one progress report while performing the one of the at least one first, second, and third task.

17. The method of claim 16, further comprising receiving quotation data for the corresponding one of the rehabilitation work, the refreshing work, and the guardianship work, the quotation data comprising at least one of a description, a cost estimate, and a schedule for the corresponding one of the rehabilitation work, the refreshing work, and the guardianship work.

18. The method of claim 17, further comprising comparing the received quotation data to guideline data retrieved from the memory, the guideline data indicative of at least one guideline applicable for performing the corresponding one of the rehabilitation work, the refreshing work, and the guardianship work, approving the quotation if the received quotation data complies with the guideline data, and rejecting the quotation otherwise.

19. The method of claim 18, further comprising receiving progress report data indicative of a progression of the corresponding one of the rehabilitation work, the refreshing work, and the guardianship work, comparing the received progress report data to the schedule for determining a status of the corresponding one of the rehabilitation work, the refreshing work, and the guardianship work, and outputting a fourth control signal comprising instructions for causing advancement of the corresponding one of the rehabilitation work, the refreshing work, and the guardianship work in accordance with the schedule.

20. The method of claim 19, further comprising detecting a deviation from the schedule of the corresponding one of the rehabilitation work, the refreshing work, and the guardianship work and outputting an alert signal indicative of the deviation.

21. The method of claim 20, further comprising detecting completion of the corresponding one of the rehabilitation work, the refreshing work, and the guardianship work and updating the status of the corresponding one of the rehabilitation work, the refreshing work, and the guardianship work accordingly.

22. The method of claim 20, further comprising determining from the received report data that the completion of the corresponding one of the rehabilitation work, the refreshing work, and the guardianship work is not satisfactory and for outputting the fourth control signal comprising instructions for performing at least one additional task for bringing the corresponding one of the rehabilitation work, the refreshing work, and the guardianship work to satisfaction.

23. A computer readable medium having stored thereon program code executable by a processor for managing repair and maintenance of at least one property, the program code executable for:
receiving vacancy notice data indicative of a vacancy of the at least one property,
retrieving from a memory maintenance history data indicative of at least one of a rehabilitation work and a refreshing work previously performed for the at least one property, the rehabilitation work comprising at least one renovation task and the refreshing work comprising at least one cosmetic repair task,
determining from the retrieved maintenance history data whether the rehabilitation work has been performed for the at least one property a predetermined time period prior to receipt of the vacancy notice data,
if the rehabilitation work has not been performed the predetermined time period prior to receipt of the vacancy notice data, outputting a first control signal comprising instructions for causing the rehabilitation work to be performed for the at least one property, and
otherwise, outputting a second control signal comprising instructions for causing the refreshing work to be performed for the at least one property.
